(19) United States
(12) Patent Application Publication
(10) Pub. No.: US 2010/0145240 A1
(43) Pub. Date: Jun. 10, 2010

(54) COMBINED MASSAGE AND EXERCISE DEVICE

(76) Inventor: Thomas Cromie, Mount Kisco, NY (US)

Correspondence Address: FISH & RICHARDSON P.C., P.O. BOX 1022, MINNEAPOLIS, MN, 55440-1022, US

(21) Appl. No.: 12/331,951

(22) Filed: Dec. 10, 2008

(51) Int. Cl. A61H 7/00; A61H 15/00

(52) U.S. Cl. 601/99; 601/134; 601/115

(57) ABSTRACT

A combined massage and exercise device includes a frame, substantially parallel, spaced-apart rollers receivable within the frame, in which each roller is rotatable around a respective roller axis intersecting a side of the frame, and a spring that provides resistance to rotational motion about the roller axis of at least one of the rollers.

### BACKGROUND

The present disclosure relates to a combined massage and exercise device. A typical massage includes the application of pressure, tension, motion, and/or vibration to a person in order to provide a particular type of relief. For example, a person may receive a massage in order to obtain pain relief, a reduction in anxiety or depression, or to reduce blood pressure and heart rate. A massage treatment can be applied to a subject manually or, in some cases, with mechanical aids.

### SUMMARY

Various aspects of the disclosure are set forth in the claims. For example, in one aspect, a massage device includes a frame as well as multiple substantially parallel, spaced-apart rollers that are receivable within the frame, in which each roller is rotatable around a respective roller axis intersecting a side of the frame. The massage device also includes a spring that provides resistance to the rotational motion of at least one of the rollers about the roller axis.

In some implementations, the spring is a torsion spring. The massage device also can include a roller end block, in which a first end of the torsion spring is coupled to one of the rollers and a second end of the torsion spring is coupled to the roller end block. The side of the frame can include an indentation adapted to receive the roller end block. The massage device also can include a channel in the side of the frame and a channel insert, in which the channel is adapted to receive the channel insert. The channel insert can restrict access to the indentation in a first position and permit access to the indentation in a second position.

In some cases, the massage device includes a slidable rack within the frame, in which the rack includes gear teeth and each of the one or more rollers includes pinion teeth to engage the gear teeth of the rack. A first end of the spring can be coupled to the frame and a second end of the spring can be coupled to the rack. The side of the frame can include a slot to receive the slidable rack.

In another aspect, a massage device includes a frame and multiple substantially parallel, spaced-apart rollers receivable within the frame, in which each roller is rotatable around a respective roller axis intersecting a side of the frame and in which each roller comprises a removable sleeve fitted to a roller axle. The massage device also can include a spring that provides resistance to the rotational motion of at least one of the plurality of rollers about the roller axis.

In some implementations, the roller axle includes a notch and the removable sleeve includes a hollow center piece bonded to an outer cover, in which the center piece has a protrusion to engage the notch on the roller axle. A hardness of the removable sleeve can vary across a length of the sleeve. The removable sleeve can include multiple removable sleeve sections, each of which has a substantially uniform hardness. The hardness of a first sleeve section can be different from the hardness of a second sleeve section. An outer diameter of a first sleeve section can be different than an outer diameter of a second sleeve section. In some cases, the frame is arranged to be reversibly collapsible.

In another aspect, a device includes a frame, substantially parallel, spaced-apart rollers receivable within the frame, in which each roller is rotatable around a respective roller axis intersecting a side of the frame, and means to provide resistance to rotational motion around the roller axis of at least one of the rollers.

The details of one or more embodiments are set forth in the accompanying drawings and the description below. Other features and advantages will be apparent from the description, the accompanying drawings, and the claims.

### BRIEF DESCRIPTION OF THE DRAWINGS

FIG. 1A shows an example of a combined massage and exercise device.

FIG. 1B illustrates a side view of the combined massage and exercise device.

FIG. 2 shows a side view of a roller.

FIG. 3 shows a perspective view of the roller.

FIG. 4 shows an example of another roller.

FIG. 5A shows an example of a sleeve section.

FIG. 5B shows a cross-section of the sleeve section.

FIG. 6A shows an example of an inner cylinder.

FIG. 6B shows a cross-section of the inner cylinder.

FIG. 7A shows a side view of a another roller.

FIG. 7B shows an exploded view of the roller of FIG. 7A.

FIG. 8 shows a side view of an end block.

FIG. 9A shows an example of a device frame.

FIG. 9B shows a projection view of a sidewall of the device frame.

FIG. 9C shows a cross-sectional view of the sidewall taken at A-A in FIG. 9A.

FIG. 10 shows an example of a pocket cover.

FIGS. 11A and 11B show top views of the pocket cover.

FIG. 12 shows a top view of rollers.

FIG. 13 shows a side view of a rack and a roller.

FIG. 14 shows a cross-section of another combined massage and exercise device.

FIG. 15 shows a projection view of a sidewall of the device of FIG. 14.

FIG. 16 shows an another example of a combined massage and exercise device.

FIG. 17 shows an another example of a combined massage and exercise device.

FIG. 18 shows a projection view of the frame sidewalls.

### DETAILED DESCRIPTION

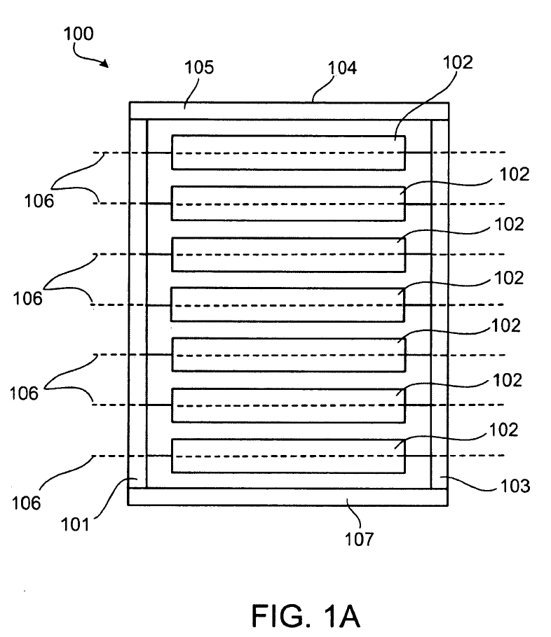

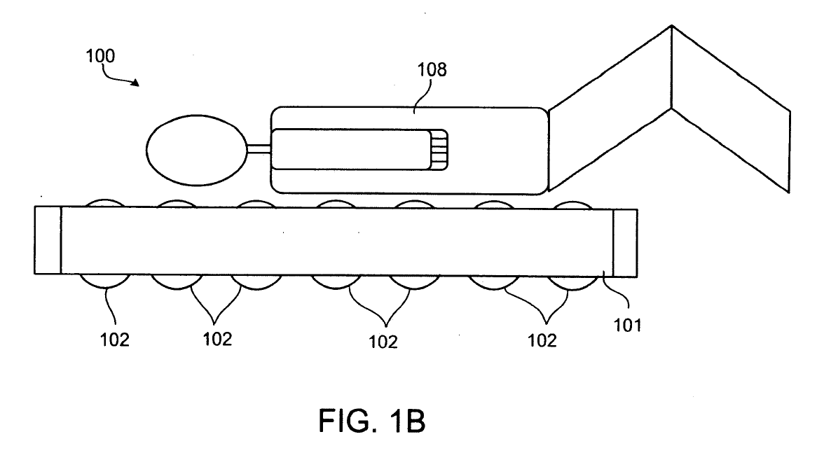

FIG. 1A shows an example of a combined massage and exercise device 100 as seen from a top view. The illustrated device 100 includes multiple spaced-apart rollers 102 arranged within a rigid frame 104. Each of the rollers 102 has a respective longitudinal axis 106, which intersects opposing side walls 101, 103 of the device frame 104. One or more of the rollers 102 is free to rotate around its respective axis. FIG. 1B illustrates a side view of the device 100 and shows how a subject (i.e., a person) 108 may position himself when using the device 100. For example, the subject 108 may lie in a supine position on the rollers 102 such that the subject is facing upwards. In some implementations, the device 100 supports the entire upper portion of a person's body from the pelvis to the top of the head. For example, the frame length, as measured along each side wall 101, 103, can be equal to about 48 inches such that the device 100 accommodates subjects of various heights. The device frame 104 may also include sidewalls 105, 107 that couple to sidewalls 101, 103 to provide a rigid frame.

To use the device 100, the subject places his feet against the ground with the knees bent and then extends his legs so that he moves horizontally across the surface of the rollers 102. As the subject moves, one or more of the rollers 102 rotates, effectively kneading the muscles of the back. In some cases, the rollers 102 exhibit a rotational resistance and/or restoring force against which the subject pushes. As the subject relaxes his legs, the restoring force allows the rollers to return to their original position. Accordingly, the device 100 can be utilized not only for purposes of massage and relaxation, but also for exercise.

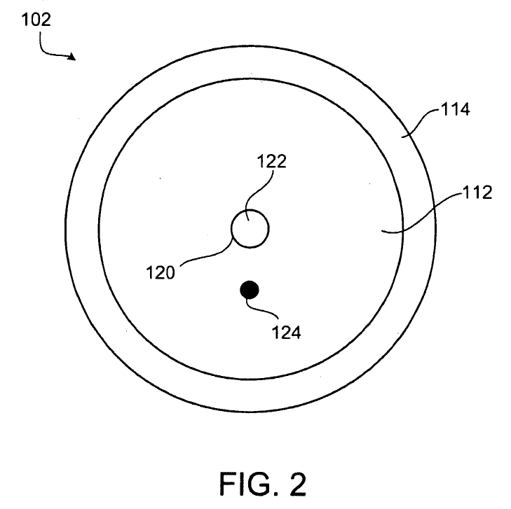

FIG. 2 shows a side view of one the rollers 102. In some implementations, the roller 102 includes a rigid inner cylinder 112 surrounded by a removable outer sleeve 114. The inner cylinder 112 can be formed from materials including, but not limited to, metal, plastic or wood. The outer sleeve 114 can be formed, for example, from a stiff foam material to cushion the subject's back. The sleeve 114 also can be formed in the shape of a cylinder with an inner diameter that is substantially equal to the outer diameter of the rigid cylinder 112. To remove the sleeve 114, it is slid over the outer surface of the inner cylinder 112. To ensure that the sleeve remains in place during rotation of the roller 102, the sleeve inner diameter 116 can be slightly less than the cylinder outer diameter 118 such that friction prevents movement of the sleeve 114 around the cylinder 112.

In the illustrated example, the inner cylinder 112 includes an elongated center opening 120 which extends the length of the cylinder and which is adapted to receive a roller axle 122. The roller 102 is designed so that it can freely rotate around the axle 122. In some cases, the roller 102 includes a second opening 124 to receive one end of a spring (not shown). As explained in more detail below, the other end of the spring can be fixed to the frame 104 or other stationary part of the device to provide resistance to the rotational motion of the cylinder 112.

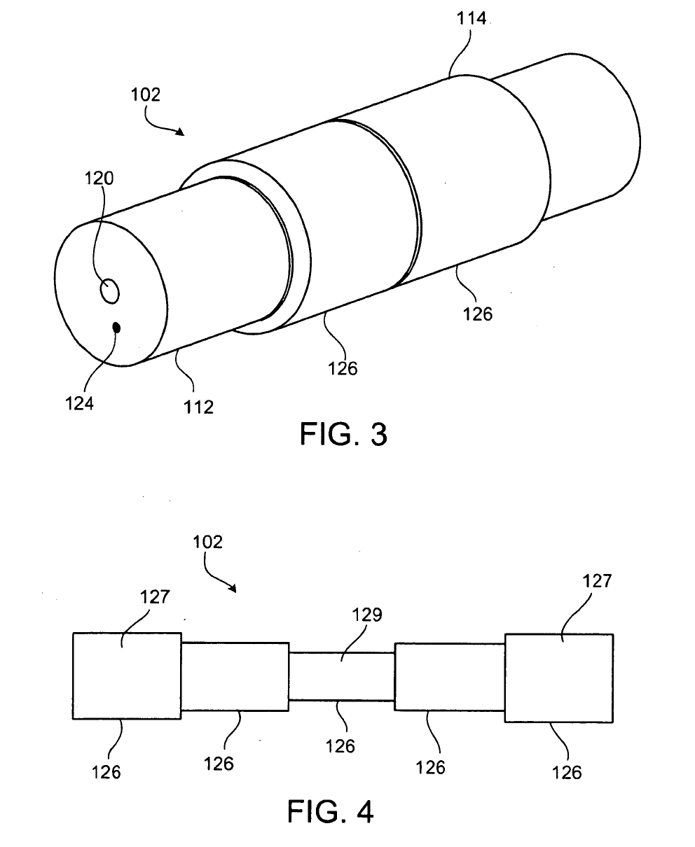

FIG. 3 shows a perspective view of the roller 102. As shown in the figure, the sleeve 114 can be formed of multiple sleeve sections 126. A user can arrange the sleeve sections 126 on each roller 102 in any desired manner. Each section 126 can have a hardness that differs from an adjacent sleeve section. In some implementations, the roller 102 can be fitted with sleeve sections 126 that are arranged to provide a pressure gradient across a subject's back. Alternatively, or in addition, the sleeve sections 126 can be arranged to relieve pressure at various regions of the subject's body. For example, in some cases, the subject may be uncomfortable as a result of his vertebrae pressing against a hard foam sleeve section. To improve comfort, the mid-point of the roller 102 (i.e., the region of the roller that aligns with the subject's vertebrae) can be arranged to include a sleeve section formed of relatively soft foam. The presence of the soft foam can reduce the pressure a subject feels against his vertebrae. Sleeve sections 126 arranged on either side of the roller mid-point then can be formed from foam that is relatively harder to provide a pressure gradient. In some cases, sleeve sections 126 formed of relatively hard foam are positioned to be in contact with areas of a subject's back that have the highest degree of muscle tension. In this manner, the user can experience greater pressure in those areas and a subsequently deeper massage.

The variation in sleeve section hardness can be obtained by using different foam material for each sleeve section. For example, a sleeve section can be formed using polyurethane foam or Santoprene™ foam. In some cases, the hardness can be varied by modifying the density of the foam material used. For example, sleeve sections 126 formed of a particular type of foam in high density would exhibit a greater hardness than sleeve sections 126 formed using the foam in low density. In some cases, the hardness of the sleeve section 126 is substantially uniform across the entire sleeve, with little or no variation.

In some implementations, each sleeve section 126 is designed to include variations in hardness. For example, a sleeve section 126 can exhibit a linear increase in hardness across the length of the sleeve. Alternatively, or in addition, the hardness of the sleeve can vary radially outward from the sleeve section's inner diameter to its outer diameter.

In some implementations, sleeve sections 126 have different lengths. For example, sleeve sections can have lengths of 1 inch or greater (e.g., 2 inches or greater, 4 inches or greater, 6 inches or greater, 8 inches or greater). In some cases, the length of the sleeve section 126 is substantially equal to the length of the inner cylinder 112 such that only a single sleeve section 126 is used.

In some cases, the outer diameter of each sleeve section 126 is varied. The outer diameter of a sleeve section can range from approximately 2 inches to 4 inches, although other sizes can be used as well. Varying the outer diameter of a sleeve section 126 also can affect the amount of pressure that a subject will experience during operation of the device 100. For example, if greater pressure is required, a larger diameter sleeve could be fitted to the inner cylinder 112. In some cases, the user may fit sleeve sections 126 of varying outer diameter, hardness and length to the rollers 102 to produce a pressure gradient across each roller 102 or across multiple rollers. FIG. 4 shows an example of a roller 102 having sleeve sections 126 with varying outside diameters. As shown in the example, the sleeve sections decrease in diameter size along the longitudinal axis from the outermost portion 127 of the roller 102 to the innermost portion 129. The smaller diameter of the sleeve sections 126 located in the innermost portion 129 of the roller 102 provides a clearance area for the subject's vertebral column. Alternatively, the sleeve sections 126 can be eliminated from the innermost portion 129 of the roller 102.

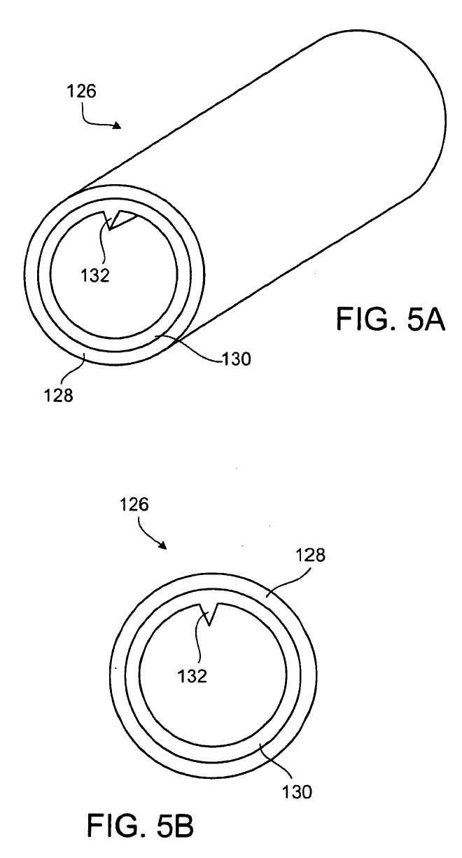

FIG. 5A shows an example of a sleeve section 126 that uses an alternative mechanism for securing the sleeve to the inner cylinder 112. In this example, the sleeve section 126 includes a plastic inner hub 130 that lines the inner diameter of the foam covering 128. The hub 130 can be fixed to the foam material 128 using glue or another adhesive. The hub 130 also can include an elongated protrusion 132 which extends along the length of the sleeve section 126. FIG. 5B shows a cross-section of the sleeve section 126 from FIG. 5A, in which the elongated protrusion 132 has a triangular shape. The elongated protrusion may have other shapes as well including, for example, rectangular, semi-circle, saw-tooth, and “T” shapes.

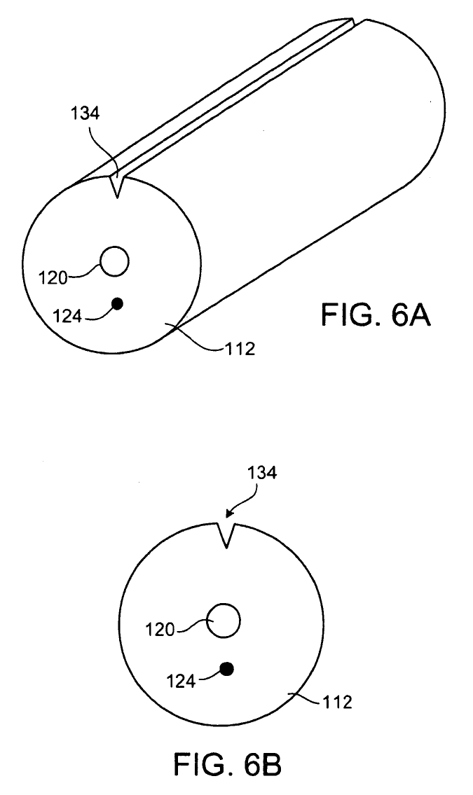

FIG. 6A shows an example of an inner cylinder 112 that can be fitted to the sleeve section 126 of FIG. 5A. The cylinder 112 includes an elongated notch 134 in its outer surface shaped to conform to and mate with the shape of the protrusion 132 formed on hub 130. For example, FIG. 6B shows a cross-section of the inner cylinder in which the notch 134 is a depression or groove that matches the triangular shape of the protrusion shown in FIG. 5B. When fitting the sleeve section 126 to the cylinder 112, a user lines up the protrusion 132 with the notch 134 and then slides the sleeve section 126 over the surface of the cylinder 112. Once fitted to the cylinder 112, the mating of the notch 134 and protrusion 132 prevents the sleeve 126 from rotating relative to the cylinder 112.

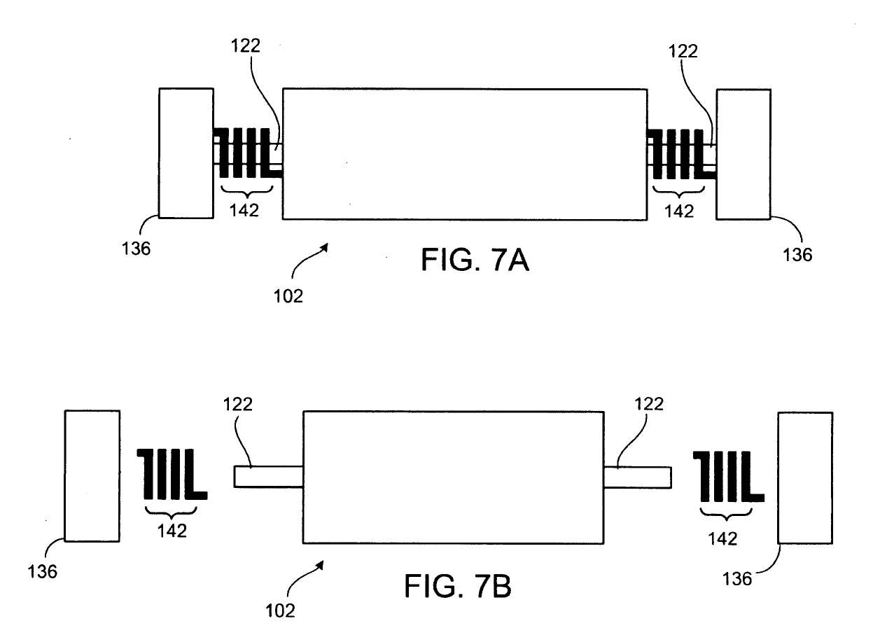

FIG. 7A shows a side view of a roller 102 removed from the device frame 104. FIG. 7B shows an exploded view of the roller 102 and end block 136. As explained above, the roller 102 is fitted to a rigid axle 122 about which the roller 102 freely rotates. The axle 122 can be formed of metal, although other materials may be used as well. Each end of the axle 122 is fitted to an end block 136, and a spring 142 is coupled to the end block 136 and to the roller 102.

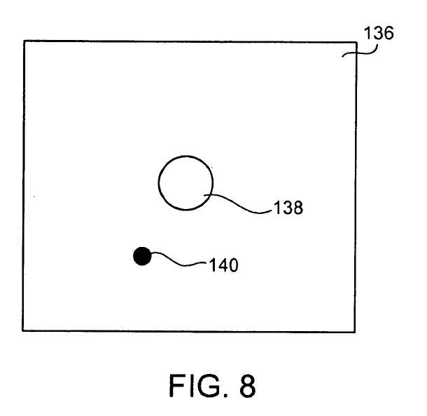

FIG. 8 shows a side view of the end block 136. To receive the axle 122, the end block 136 includes an axle opening 138 in its center. The diameter of the axle opening 138 is substantially equal to the diameter of the axle 122. The end block 136 also can include a spring receiving portion 140 to connect to the spring 142 between the end block 136 and roller 102. As explained above, the spring 142 provides rotational resistance to the roller motion when the subject extends his legs when using the device 100. For example, the spring 142 can be a torsion spring, which is a flexible elastic object that stores mechanical energy when it is twisted. Accordingly, one end of a torsion spring can be connected to the roller 102, and the other end can be connected to the end block 136 or another stationary point on the frame 104. When the roller 102 is turned, the torsion spring stores energy based on rotation of the roller.

When the roller 102 subsequently is released or a rotational force is no longer applied, the torsion spring exerts a torque which attempts to return the roller 102 to its original position. The amount of torque the torsion spring exerts is proportional to the amount it is twisted. The spring 142 can be made from a wire, ribbon, or bar of metal or rubber. In some cases, the spring receiving portion 140 is a hook that protrudes from the end block 136 which can be coupled to the spring 142. In some implementations, the spring receiving portion 140 is located within a recession or hole in the end block 136 adjacent to the axle opening 138. One end of the spring 142 can connect to the spring receiving portion 140. The other end of the spring 142 can connect to the second opening 124 formed in the roller 102. As shown in FIG. 7B, the axle 122 passes through the spring 142 and is fitted to the opening 138 in the end block 136.

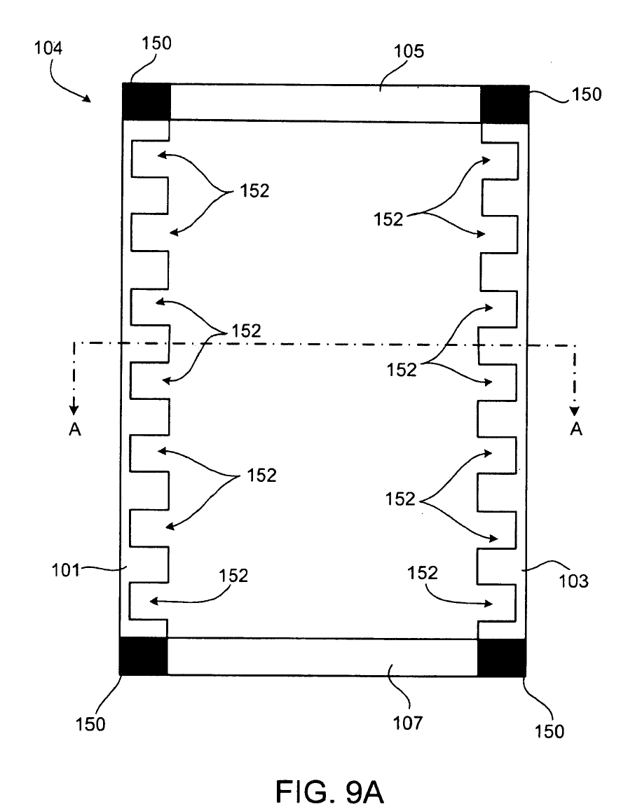

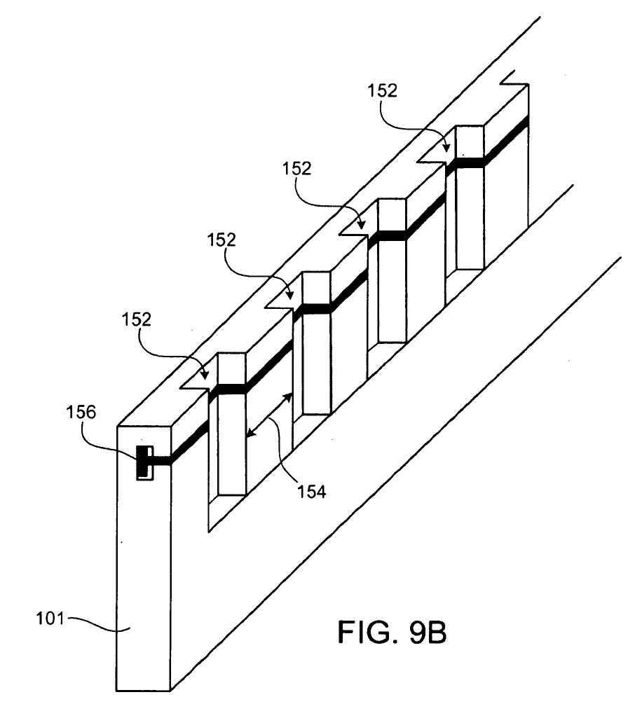

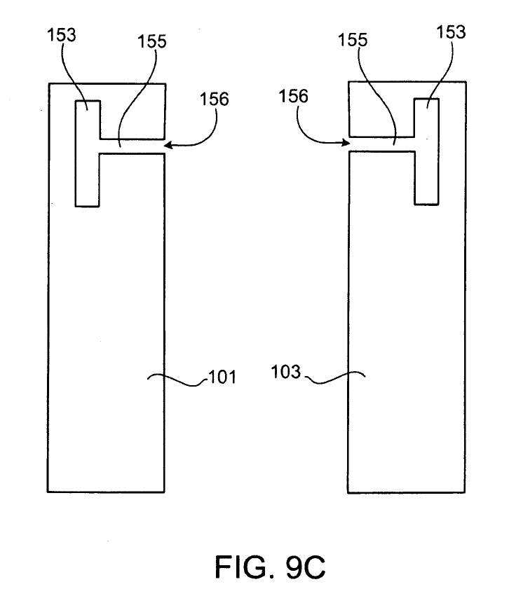

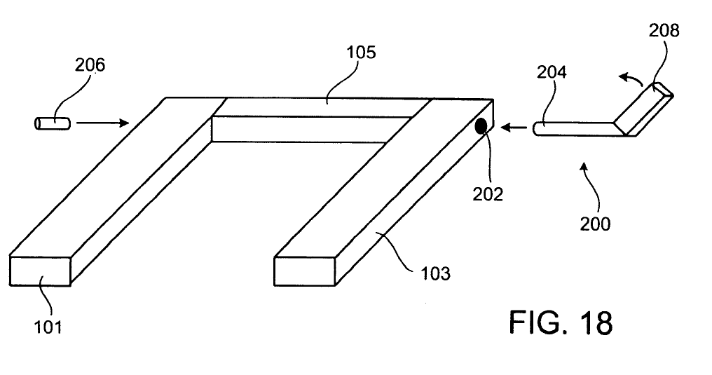

FIG. 9A shows an example of the device frame 104, which includes rigid cross members that form the frame sidewalls (101, 103, 105, 107). The sidewalls can be formed, for example, of metal, wood or plastic. Other materials may be used to form the sidewalls as well. In the example of FIG. 9A, the device frame 104 is in fully assembled form and is rectangular in shape. The device frame 104 may be designed to take on other shapes when fully assembled including, for example, oval, elliptical, or semi-circle shapes. The sidewalls of the device frame 104 can be secured together using links 150 fitted to the ends of the sidewalls and can include fixed pieces such as bolts, screws, or nails. In some embodiments, the links 150 can be hinges that allow the sidewalls 101, 103, 105, 107 to be folded in a compact manner without the need to disassemble the device frame 104. In the collapsed form, the device 100 utilizes less space and may be stored more easily than in the fully assembled form. Similarly, the hinges also can allow the device 100 to be returned to the fully assembled form from the collapsed form without the need to disconnect or reconnect the sidewalls of the device frame 104. Additional hinges may be located at approximately the center of each sidewall to facilitate folding of the device frame 104. Accordingly, a device 100 that incorporates hinges can be reversibly collapsible. In some embodiments, the device 100 can include quick release locks to hold the frame sidewalls together. For example, FIG. 18 shows a projection view of the frame sidewalls 101, 103 and 105 in which a quick release lock 200 is used to secure the walls. The quick release lock 200 includes a rod 204 that can be inserted into opening 202 of sidewall 103. It passes through the center of sidewall 105 and through another opening at the end of sidewall 101. The end of the rod 204 that protrudes from sidewall 101 is threaded so that it may couple to a nut 206. A cam/lever assembly 208 is fixed to the other end of the rod 204. When inserted through the sidewalls, the lever 208 can be folded to apply tension to the rod and thus secure the sidewalls together.

On the inside face of sidewalls 101, 103 of the illustrated example, the device frame 104 includes a series of pockets 152 adapted to receive the end blocks 136 fitted to the rollers 102. FIG. 9B shows a perspective view of the sidewall 101. As shown in that figure, the pockets 152 correspond to openings or indentations in sidewall 101. The pockets 152 can be open at the top of sidewall 101 and closed at the bottom such that the end blocks 136 can be dropped into place. The length and width of each pocket 152 are substantially equal to the length and width of each end block 136. The pockets 152 may be spaced apart by a block distance 154 so that a separation between rollers 102 can be maintained. The construction and shape of sidewall 103 essentially mirrors that of sidewall 101.

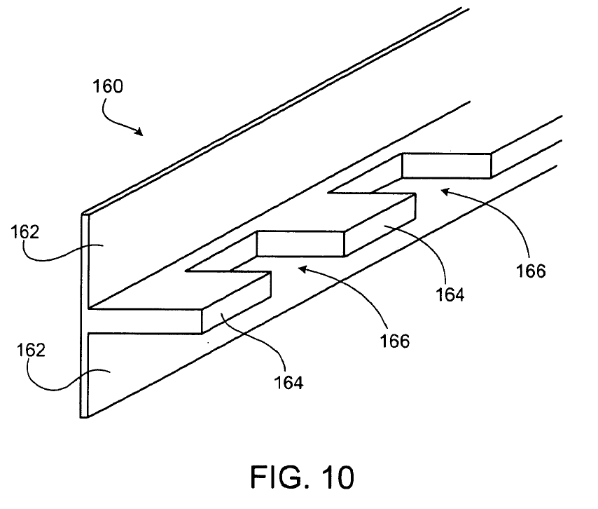

In addition, each sidewall 101, 103 can include a channel 156 for receiving a channel insert or pocket cover 160 (see FIG. 10). The channel 156 can be, for example, a groove that extends along the length of each sidewall. FIG. 9C shows a cross-sectional view of the sidewall 101 taken along A-A in FIG. 9A. As shown in the examples of FIGS. 9B and 9C, the channel 156 includes a vertical cavity 153 and a horizontal cavity 155, which intersect each other in the shape of the letter “T” that has been rotated by 90 degrees. The horizontal cavity 155 extends away from the vertical cavity 153 and opens to the inner region of the device frame 104.

FIG. 10 shows an example of the pocket cover 160 which can be inserted into the channel 156. The pocket cover 160 includes a back wall portion 162 and a middle wall portion 164 that intersects the back wall 162. The middle wall portion 164 can include a series of cuts or openings 166. The interval between the openings 166 matches the distance between each pocket 152 located in the sidewall 101. The shape formed by the back wall portion 162 and the middle wall portion 164, as viewed from the side, matches the rotated “T” shape formed by the channel 156 such that the cover 160 can be readily inserted into the channel. When inserted into the channel 156, the pocket cover 160 covers the openings of each pocket 152 so that the end blocks 136 cannot be removed.

For example, when the pocket cover 160 is inserted into the channel 156 of sidewall 101, the cover 160 can be moved between two different positions. FIG. 1A shows a top view of the pocket cover 160 in a first position in sidewall 101, in which the openings of the pocket cover 160 are aligned with the openings of each pocket 152 in sidewall 101. In the first position, each pocket 152 is open to receive the corresponding end block 136 (i.e., a user may add a roller 102 into the device frame 104 by inserting the end block 136 into the pocket 152). Alternatively, a user could remove the end block 136 from the opening to exchange rollers, replace the roller sleeve 114 or rearrange sleeve sections 126 which are fitted to the roller 102. The middle wall portions 164, in contrast, are located within the horizontal cavities 155 of the channel 156.

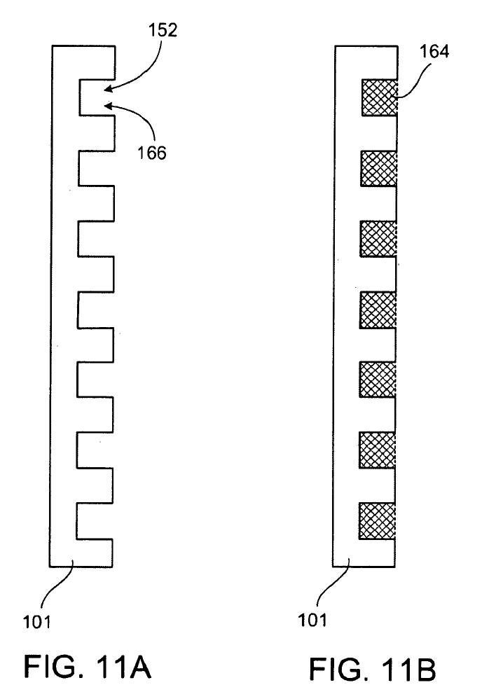

FIG. 11B shows the pocket cover 160 laterally shifted to a second position in which the openings 166 of the pocket cover 160 are now located within the cavities 155 of the channel 156. The middle wall portions 164, on the other hand, are aligned with the location of pockets 152. Accordingly, the middle wall portion 164 confines the end block 136 (and the roller, if fixed to the end block 136) to the device frame 104 and can prevent it from falling out during operation or movement of the device 100.

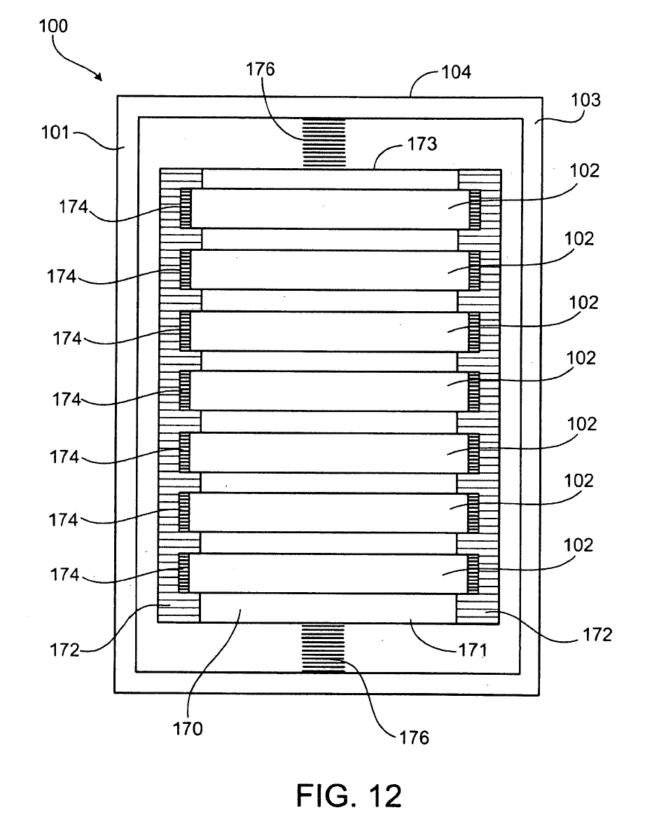

In some implementations, the resistance to roller motion is provided using a rack and pinion arrangement. For example, FIG. 12 shows a top view of rollers 102 supported by a slidable rack 170 within the device frame 104. The rack 170 can include teeth 172 that engage circular pinions 174 located at the end of each roller 102. The rack 170 is coupled to the sidewalls 101, 103 of the device frame 104 and is free to slide along a single axis. The rack 170 is not weight bearing. Instead, vertical loads are supported by the roller axles 122 and the device frame 104.

The implementation shown in FIG. 12 does not include, however, a spring connected to each roller 102. Instead, one or more springs 176 can be connected between the bottom side 171 of the rack 170 and the device frame 104. Alternatively, or in addition, one or more springs 176 can be connected between the top side 173 of the rack 170 and the device frame 104. Accordingly, the resistance to motion is provided by the tension and/or compression that occurs in the springs 176 as the rack 170 moves.

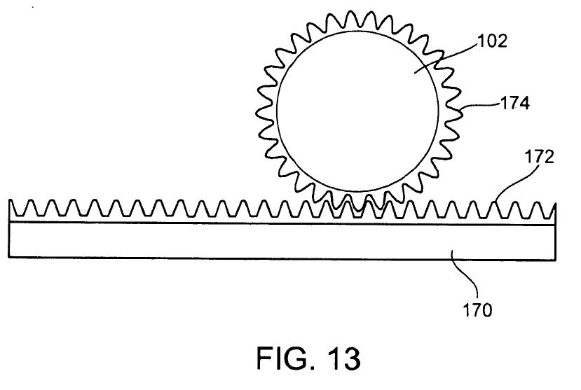

For example, to use the device 100, the subject places his feet against the ground with the knees bent and then extends his legs to move his body horizontally across the surface of the rollers 102. As the subject's body moves, the rollers 102 rotate such that each of the circular pinions 174 engage the teeth 172 on the rack 170. FIG. 13 shows a side view of the rack 170 and roller 102. As shown in FIG. 13, the pinion 174 of the roller 102 can engage the teeth 172 on the rack 170. Referring again to FIG. 12, the rotational motion applied to each pinion 174 causes the rack 170 to move in the opposite direction of the subject, up to the limit of the rack's travel. The resistance to motion of the rack 170, and thus the rollers 102, is provided by the spring 176. As the rack 170 moves in the direction of the subject's feet, the spring 176 will either compress (when located at the bottom side 171 of the rack 170) or expand (when located at the top side 173 of the rack 170) giving rise to a restoring force proportional to the length of compression or extension of the spring 176. The restoring force can be felt as resistance in the rollers 102 which can be used to enhance the massage effect. When the subject relaxes his legs, the spring 176 attempts to move the rack 170, and thus the rollers 102, back to their original position.

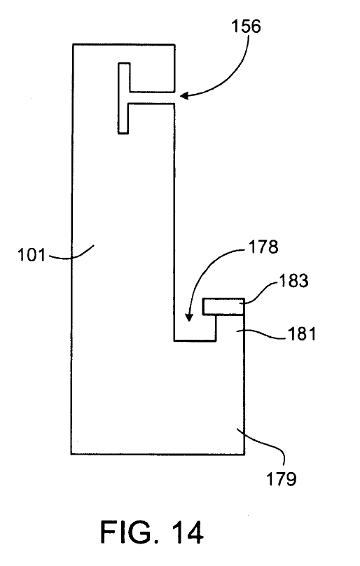

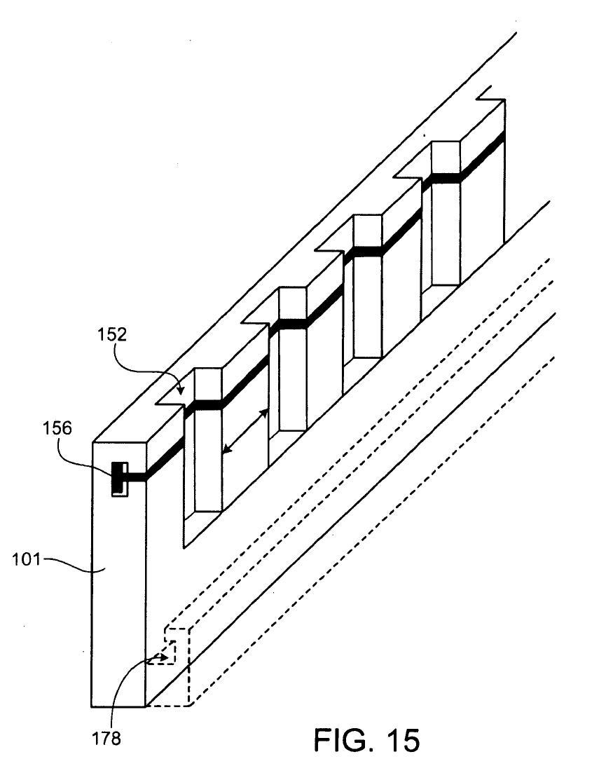

FIG. 14 shows a cross-section of the device 100 in which the sidewall 101 includes a slot 178 to receive the rack 170. The slot 178 is formed by a horizontal wall portion 179 and a vertical wall portion 181 that are integral to the sidewall 101. In some cases, a top portion 183 may be formed on the vertical portion 181 to keep the rack slidably positioned within the slot 178. The rack 170 can include bearings or wheels that are positioned within the slot 178 and which allow the rack 170 to slide as the rollers 102 are actuated. FIG. 15 shows a perspective view of the sidewall 101 and the slot 178. As before, end blocks 136 fitted to the roller axle 122 can be positioned in pockets 152 formed in the sidewall 101. In addition, the pocket cover 160 can be inserted into the channel 156 either to hold the end blocks 136 and rollers 102 in place or to allow a user to remove, replace or modify the rollers 102.

A number of implementations of the invention have been described. Nevertheless, it will be understood that various modifications may be made without departing from the spirit and scope of the invention.

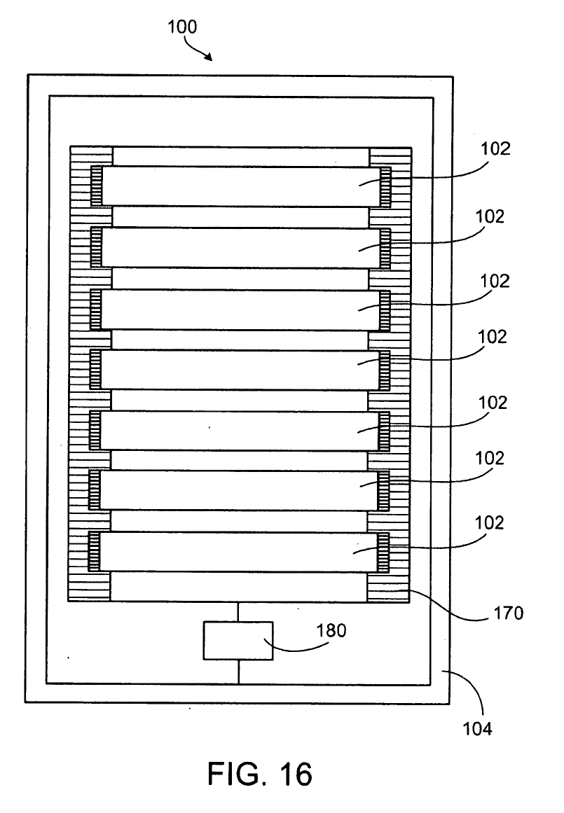

For example, in some implementations, the rack 170 can be driven by a motor instead of by the subject's own force. FIG. 16 shows a massage device 100 in which a motor 180 is coupled between the rack 170 and the device frame 104. The motor 180 drives the motion of the rack 170 along a track formed in the sidewalls 101, 103 of the device frame 104. As a result, the device 100 can provide automatic movement of the subject across rollers 102.

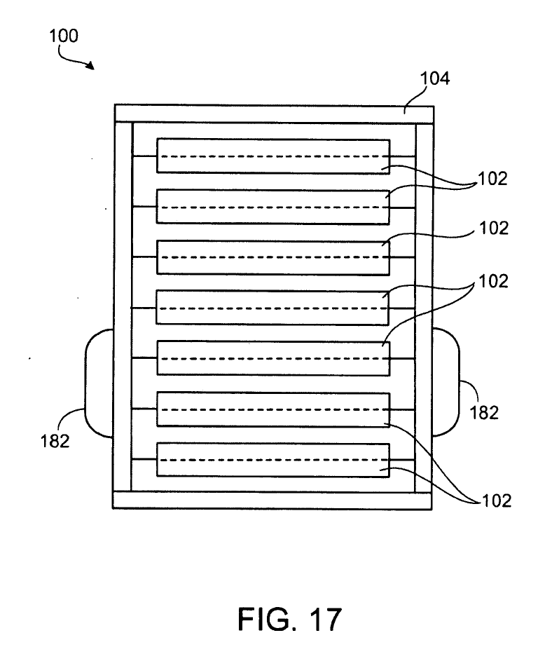

In some implementations, one or more handles may be attached to the sidewalls. FIG. 17 illustrates an example of a device that includes handles 182 attached to sidewalls 101, 103. The handles 182 may be used by the subject to assist moving the subject's body across the rollers 102. Accordingly, the handles 182 may be useful in providing a means of exercise for the subject's arms.

Other implementations are within the scope of the claims.

What is claimed is:

1. A combined massage and exercise device comprising:
a frame;
a plurality of substantially parallel, spaced-apart rollers receivable within the frame, wherein each roller is rotatable around a respective roller axis intersecting a side of the frame; and
a spring that provides resistance to rotational motion about the roller axis of at least one of the plurality of rollers.

2. The massage device according to claim 1 wherein the spring is a torsion spring.

3. The massage device according to claim 2 further comprising a roller end block, wherein a first end of the torsion spring is coupled to one of the rollers and a second end of the torsion spring is coupled to the roller end block.

4. The massage device according to claim 3 wherein the side of the frame comprises an indentation adapted to receive the roller end block.

5. The massage device according to claim 4 further comprising:
a channel in the side of the frame; and
a channel insert,
wherein the channel is adapted to receive the channel insert such that the channel insert restricts access to the indentation in a first position and the channel insert permits access to the indentation in a second position.

6. The massage device according to claim 1 further comprising a slidable rack within the frame, wherein the rack includes gear teeth and wherein each of the one or more rollers includes pinion teeth to engage the gear teeth of the rack.

7. The massage device according to claim 6 wherein a first end of the spring is coupled to the frame and a second end of the spring is coupled to the rack.

8. The massage device according to claim 6 wherein the side of the frame includes a slot to receive the slidable rack.

9. A combined massage and exercise device comprising:
a frame;
a plurality of substantially parallel, spaced-apart rollers receivable within the frame, wherein each roller is rotatable around a respective roller axis intersecting a side of the frame and wherein each roller comprises a removable sleeve fitted to a roller axle; and
a spring that provides resistance to rotational motion about the roller axis of at least one of the plurality of rollers.

10. The massage device according to claim 9 wherein the roller axle comprises a notch and wherein the removable sleeve comprises a hollow center piece bonded to an outer cover, the center piece having a protrusion to engage the notch on the roller axle.

11. The massage device according to claim 9 wherein a hardness of the removable sleeve varies across a length of the sleeve.

12. The massage device according to claim 9 wherein the removable sleeve comprises a plurality of removable sleeve sections each of which has a substantially uniform hardness.

13. The massage device according to claim 12 wherein the hardness of a first sleeve section is different from the hardness of a second sleeve section.

14. The massage device according to claim 12 wherein an outer diameter of a first sleeve section is different than an outer diameter of a second sleeve section.

15. The massage device according to claim 9 wherein the frame is arranged to be reversibly collapsible.

16. A device comprising:
a frame;
a plurality of substantially parallel, spaced-apart rollers receivable within the frame, wherein each roller is rotatable around a respective roller axis intersecting a side of the frame; and
means to provide resistance to rotational motion around the roller axis of at least one of the plurality of rollers.
